(19) United States
(12) Patent Application Publication
(10) Pub. No.: US 2026/0012911 A1
(43) Pub. Date: Jan. 8, 2026

(54) TIMING ADVANCE VALIDATION FOR SMALL DATA TRANSMISSION BY WIRELESS DEVICE

(71) Applicant: Apple Inc., Cupertino, CA (US)

(72) Inventors: Jie CUI, San Jose, CA (US); Dawei ZHANG, Saratoga, CA (US); Fangli XU, Beijing (CN); Hong HE, San Jose, CA (US); Manasa RAGHAVAN, Sunnyvale, CA (US); Qiming LI, Beijing (CN); Rolando E. BETTANCOURT ORTEGA, Munich, Bavaria-Bayern (DE); Xiang CHEN, Campbell, CA (US); Yang TANG, San Jose, CA (US); Yuexia SONG, Beijing (CN)

(21) Appl. No.: 19/101,886

(22) PCT Filed: Aug. 8, 2022
(86) PCT No.: PCT/CN2022/110804

§ 371 Date: Feb. 6, 2025

(51) Int. Cl. H04W 56/00; H04W 74/0833; H04W 76/27

(52) U.S. Cl. CPC H04W 56/0045; H04W 74/0833; H04W 76/27

(57) ABSTRACT

This application regards timing advance (TA) validation for small data transmission (SDT) by a wireless device. The wireless device calculates a RSRP value based on a receipt of one or more messages, where the particular messages to trigger the RSRP calculation can be indicated to the wireless device by a flag in a message received from a cellular wireless network. Exemplary messages include a radio resource control (RRC) release message, with or without a SDT configuration, a medium access control (MAC) control element (CE) TA command message, or a random-access response (RAR) message. The wireless device measures and stores the RSRP value to use for subsequent validation of a TA value.

### FIELD

The described embodiments relate to wireless communications, including methods and apparatus to perform timing advance (TA) validation for small data transmission (SDT) by a wireless device.

### BACKGROUND

Newer generation, e.g., fifth generation (5G) new radio (NR), cellular wireless networks that implement one or more 3^{rd} Generation Partnership Project (3GPP) 5G standards are rapidly being developed and deployed by network operators worldwide. The newer cellular wireless networks provide a range of packet-based services, with 5G technology providing increased data throughput and lower latency connections that promise enhanced mobile broadband services for wireless devices. The higher data throughput and lower latency of 5G is expected to usher in a range of new applications and services as well as improve existing ones. Communicating small amounts of data, with attendant signaling overhead while in a radio resource control (RRC) connected state with a cellular wireless network, can be inefficient for both the wireless device and the cellular wireless network. To improve signaling efficiency, a wireless device can instead transmit limited amounts of data while in an RRC inactive state with the cellular wireless network. The cellular wireless network can provide a configured grant (CG) allocating time periods for the wireless device to use for small data transmission (SDT) while in the RRC inactive state. Before sending uplink (UI.) data during a CG-SDT occasion in an unlicensed radio frequency (RF) band, the wireless device acquires downlink (DL) timing synchronization and validates a timing advance (TA) value used to align UL transmissions to the cellular wireless network. The wireless device measures reference signals received at multiple times and via multiple antennas as part of a TA validation procedure. There exists a need for mechanisms to manage TA validation including filtering of received reference signals used therewith.

### SUMMARY

The described embodiments relate to wireless communications, including methods and apparatus to perform timing advance (TA) validation and beam filtering for small data transmission (SDT) by a wireless device. The wireless device is configured to transmit limited amounts of data while in a radio resource control (RRC) inactive state with a cellular wireless network. The cellular wireless network can provide a configured grant (CG) allocating time periods for small data transmission (SDT) to the wireless device in an RRC release message when transitioning the wireless device from an RRC connected state to the RRC inactive state (or while in the RRC inactive state). The RRC release message with the SDT configuration can include a timing advance (TA) value for the wireless device to use for time alignment of UL communication transmitted to the cellular wireless network. The cellular wireless network can also provide a TA value to the wireless device in a medium access control (MAC) control element (CE) TA command message while the wireless device is in the RRC connected state or in the RRC inactive state. The cellular wireless network can further provide a TA value to the wireless device in a random-access response (RAR) message, as part of a random-access channel (RACH) procedure, while the wireless device is in the RRC connected state, in the RRC inactive state, or in an RRC idle state.

In some embodiments, the cellular wireless network includes a flag in an RRC message, such as the RRC release message that includes the SDT configuration, the flag indicating when the wireless device should measure, update, and store a reference signal received power (RSRP) value, designated RSRP1, to be later used for validating a TA value as part of an SDT procedure. The wireless device measures a portion of a downlink (DL) synchronization signal block (SSB) to determine the RSRP1 value. The flag received from the cellular wireless network can indicate whether the wireless device updates and stores the RSRP1 value: i) only in response to receipt of an RRC release message that includes a SDT configuration (and not in response to a MAC CF TA command message or a RAR message that includes a TA value), ii) only in response to receipt of a MAC CE TA command message or a RAR message that includes a TA value (and not in response to an RRC release message with a SDT configuration), or iii) in response to receipt of any one of: an RRC release message with or without a SDT configuration, a MAC CE TA command message, or a RAR message that includes a TA value.

In some embodiments, the wireless device updates and stores the RSRP1 value i) when transitioning from the RRC connected state to the RRC inactive state, in response to receipt of an RRC release message with a SDT configuration, and ii) when receiving a MAC CE TA command or a RAR message that includes a TA value, while in the RRC inactive state.

In some embodiments, the wireless device updates and stores the RSRP1 value i) when transitioning from the RRC connected state to the RRC inactive state, in response to receipt of an RRC release message with a SDT configuration, and ii) when transitioning from the RRC inactive state to the RRC inactive state, in response to receipt of another RRC release message with a SDT configuration.

The wireless device can measure the RSRP values by receiving the DL SSB via multiple antennas using a beam sweeping mechanism. The wireless device can perform physical layer one (L1) filtering to combine one or more sets of received RSRP sample values obtained in an L1 filtering window to determine a single RSRP sample value. Each set of received RSRP sample values can include measurements of the SSB received via different receive beams. In some embodiments, the wireless device determines a receive beam having a strongest RSRP value in a single set of received RSRP sample values and performs L1 filtering using the strongest RSRP value from the single set of received RSRP sample values and additional RSRP sample values from the same receive beam, which can be taken without additional beam sweeping. In some embodiments. the wireless device performs L1 filtering separately for each receive beam across multiple sets of received RSRP sample values to determine an L1 filtered RSRP sample value for each receive beam and then selects the strongest L1 filtered RSRP value (associated with one of the receive beams) as the single RSRP sample value. In some embodiments, the wireless device selects a highest RSRP sample value in each set of received RSRP sample values, which can be from different receive beams in each set. and then performs L1 filtering to combine the highest values from each set to determine the single RSRP sample value. In some embodiments, the wireless device performs L1 filtering across all received RSRP sample values of two or more sets of received RSRP sample values within the L1 filtering window to determine the single RSRP sample value. In some embodiments, the wireless device performs L1 filtering across all received RSRP sample values in all sets of received RSRP sample values within the L1 filtering window to determine the single RSRP sample value. L1 filtering can include a weighted average of RSRP sample values.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates a block diagram of different components of an exemplary system configured to perform small data transmission (SDT) communication by a wireless device, according to some embodiments.

FIG. 1B illustrates a block diagram of radio resource control (RRC) states for a wireless device, according to some embodiments.

FIG. 1C illustrates a chart of exemplary messaging between a wireless device and a cellular wireless network to perform SDT communication, according to some embodiments.

FIG. 1D illustrates a diagram of an exemplary set of actions performed by a wireless device for an SDT, according to some embodiments.

FIG. 2A illustrates a diagram of an example of beam sweeping by a wireless device, according to some embodiments.

FIG. 2B illustrates a diagram of an example of physical layer 1 (L1) filtering of reference signal received power (RSRP) sample values based on a strongest beam in a beam sweeping set by a wireless device, according to some embodiments.

FIG. 2C illustrates a diagram of an example of L1 filtering of RSRP sample values received via individual beams across multiple beam sweeping sets by a wireless device, according to some embodiments.

FIG. 2D illustrates a diagram of an example of L1 filtering of RSRP sample values using strongest RSRP sample values from each of multiple beam sweeping sets by a wireless device, according to some embodiments.

FIG. 2E illustrates a diagram of an example of L1 filtering of RSRP sample values using all RSRP sample values from multiple beam sweeping sets by a wireless device, according to some embodiments.

FIGS. 3A, 3B, and 3C illustrates flowcharts of exemplary methods to update an RSRP value, such as used for validating a timing advance (TA) value before sending a small data transmission (SDT), according to some embodiments.

FIGS. 4A, 4B, 4C, and 4D illustrates flowcharts of exemplary methods to determine an RSRP value via beam sweeping, according to some embodiments.

FIG. 5 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

This application regards methods and apparatus to perform timing advance (TA) validation and beam filtering for small data transmission (SDT) by a wireless device. The wireless device is configured to transmit limited amounts of data while in a radio resource control (RRC) inactive state with a cellular wireless network. The cellular wireless network can provide a configured grant (CG) allocating time periods for small data transmission (SDT) to the wireless device in an RRC release message when transitioning the wireless device from an RRC connected state to the RRC inactive state (or while in the RRC inactive state). The RRC release message with the SDT configuration can include a timing advance (TA) value for the wireless device to use for time alignment of UL communication transmitted to the cellular wireless network relative to downlink (DL) communication received from the cellular wireless network. The TA value can be updated by the cellular wireless network to account for changes in the communication channel between the wireless device and the cellular wireless network. The cellular wireless network can provide a TA value to the wireless device in a medium access control (MAC) control element (CE) TA command message while the wireless device is in the RRC connected state or while the wireless device is in the RRC inactive state. The cellular wireless network can further provide a TA value to the wireless device using a random-access response (RAR) message, e.g., as part of a random-access channel (RACH) procedure initiated by the wireless device, while the wireless device is in the RRC connected state, while the wireless device is in the RRC inactive state, or while the wireless device is in an RRC idle state.

In some embodiments, the cellular wireless network provides information to the wireless device to configure the wireless device to measure and store a reference signal received power (RSRP) value, designated RSRP1, to be later used for validating a TA value as part of an SDT procedure. In some embodiments, the cellular wireless network includes a flag in a RRC message sent to the wireless device, e.g., such as in an RRC release message that includes an SDT configuration, the flag indicating when the wireless device should measure, update, and store the RSRP1 value. The RSRP1 value provides a signal strength measurement associated with a TA value received from the wireless network. and the wireless device can later compare an additional signal strength measurement to the stored RSRP1 value to determine whether the stored TA value is still valid to be used. Changes in the signal strength can indicate changes in the communication channel between the wireless device and the cellular wireless network that requires an update to the TA value to be used by the wireless device. The wireless device measures a portion of a downlink (DL) synchronization signal block (SSB) to determine the RSRP1 value. The flag can indicate whether RSRP1 measurements are based on RRC state transitions, based on MAC CE or RAR messages, or based on combinations of RRC state transitions and MAC CE or RAR messages. In some embodiments, the flag received from the cellular wireless network provides an indication that the wireless device should update and store the RSRP1 value only in response to receipt of an RRC release message that includes an SDT configuration (and not in response to a MAC CE TA command message or a RAR message that includes a TA value). In some embodiments, the flag received from the cellular wireless network provides an indication that the wireless device should update and store the RSRP1 value only in response to receipt of a MAC CE TA command message or a RAR message that includes a TA value (and not in response to RRC release messages). In some embodiments, the flag received from the cellular wireless network provides an indication that the wireless device should update and store the RSRP1 value in response to receipt of an RRC release message with or without an SDT configuration, in response to receipt of a MAC CE TA command message, or in response to receipt of a RAR message that includes a TA value.

In some embodiments, the wireless device is configured to measure and store the RSRP1 value without receiving a flag in a configuration message regarding RSRP1 measurements from the cellular wireless network. In some embodiments, the wireless device is configured for RSRP1 measurements based on a cellular wireless network setting provided to the wireless device in a carrier bundle that includes settings for one or more cellular wireless networks. In some embodiments, the wireless device is configured for RSRP1 measurements based on a system information broadcast (SIB) message received from the cellular wireless network. In a first configuration, the wireless device can update and store the RSRP1 value i) when transitioning from the RRC connected state to the RRC inactive state, in response to receipt of an RRC release message with an SDT configuration, and ii) when receiving a MAC CE TA command or when receiving an RAR message that includes a TA value, while in the RRC inactive state. In a second configuration, the wireless device can update and store the RSRP1 value i) when transitioning from the RRC connected state to the RRC inactive state, in response to receipt of an RRC release message with an SDT configuration, and ii) when transitioning from the RRC inactive state to the RRC inactive state, in response to receipt of an RRC release message with an SDT configuration. In the second configuration, the wireless device can refrain from updating the stored RSRP1 value when receiving a MAC CE TA command or when receiving an RAR message that includes a TA value and only update the stored RSRP1 value in response to receipt of an RRC release message with an SDT configuration.

Later, when the wireless device determines UL data is available for CG-SDT transmission, while in the inactive state, the wireless device performs a TA validation procedure using the RSRP1 value. The wireless device calculates a second RSRP value, designated RSRP2, by remeasuring the signal strength and compares a magnitude of a difference between RSRP1 and RSRP2 to an RSRP change threshold value applicable to SDT to determine whether the previously received TA value remains valid. Substantial changes in the RSRP value can indicate the communication channel between the wireless device and the cellular wireless network has changed such that the previously received TA value may be stale and need to be updated by the cellular wireless network. After successful validation of the TA value, the wireless device acquires timing synchronization with the cellular wireless network during one or more timing synchronization occasions before a CG-SDT occasion on which to transmit a portion of the UL data.

The wireless device can measure the RSRP values by receiving the DL SSB via multiple antennas using a beam sweeping mechanism. The wireless device can measure multiple RSRP sample values through different receive beams over a time period. The wireless device performs physical layer once (L1) filtering to combine one or more sets of received RSRP sample values obtained during the time period, also referred to as an L1 filtering window, to determine a single RSRP sample value for RSRP1 or RSRP2. Each set of received RSRP sample values includes measurements of the SSB received via different receive beams. In some embodiments, the wireless device selects a receive beam that has a strongest RSRP value in a set of received RSRP sample values and performs L1 filtering by combining the strongest RSRP value from the set with additional RSRP values from the same receive beam in one or more additional sets of received RSRP sample values. In some embodiments, the wireless device selects a receive beam with the strongest RSRP value from a first set of RSRP values and subsequently measures one or more additional RSRP sample values using the same receive beam (without additional beam sweeping after the first set of received RSRP sample values). In some embodiments, the wireless device performs L1 filtering separately for each receive beam across multiple sets of received RSRP sample values to determine an L1 filtered RSRP sample value for each receive beam and then selects the strongest L1 filtered RSRP value (associated with one of the receive beams) as the single RSRP sample value. In some embodiments, the wireless device selects a highest RSRP sample value in each set of received RSRP sample values, where the highest RSRP sample value in each set of received RSRP sample values can be from different receive beams. The wireless device can then perform L1 filtering to combine the highest RSRP sample values from each set to determine the single RSRP sample value. In some embodiments, the wireless device performs L1 filtering across all received RSRP sample values of two or more sets of received RSRP sample values within the L1 filtering window to determine the single RSRP sample value. In some embodiments, the wireless device performs L1 filtering across all received RSRP sample values received within the L1 filtering window to determine the single RSRP sample value. L1 filtering can include a weighted averaging.

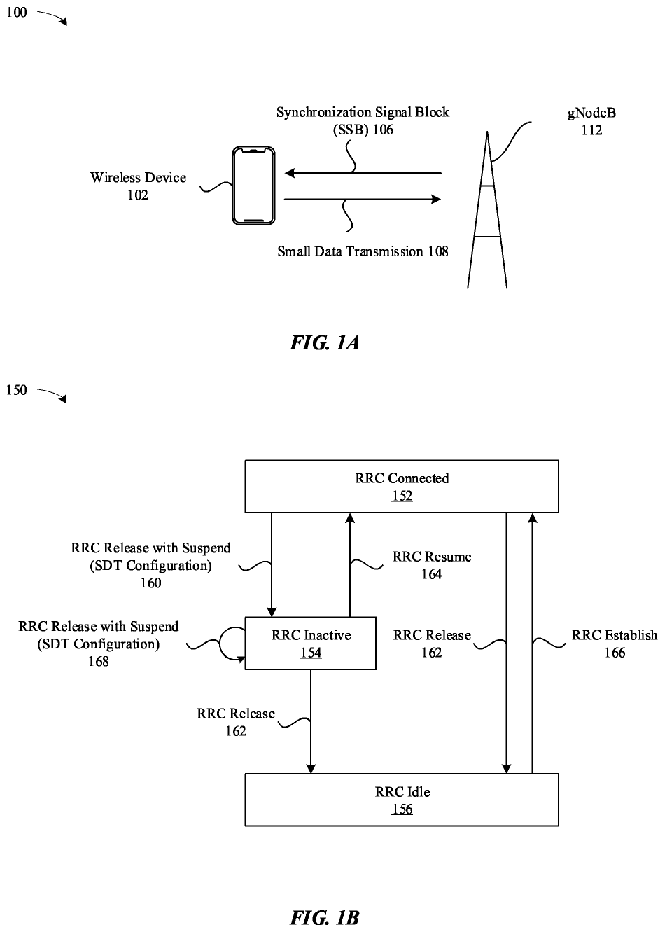

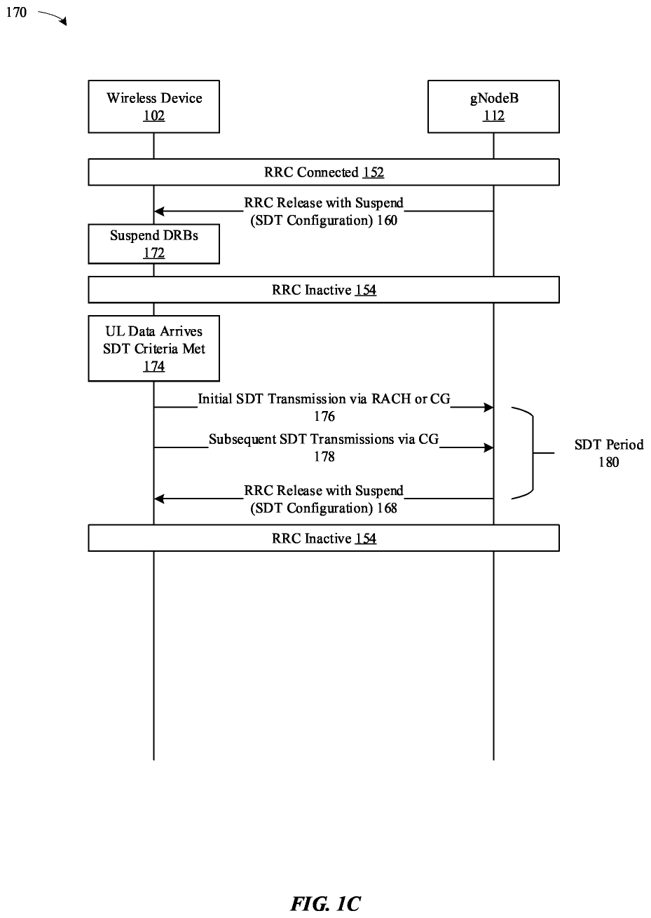

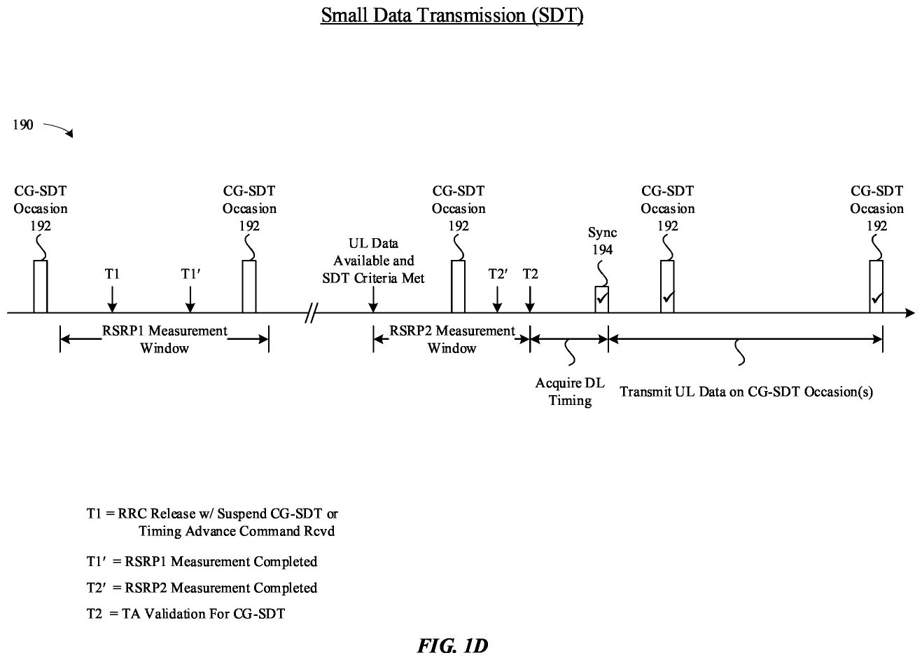

These and other embodiments are discussed below with reference to FIGS. 1 through 4; however, those skilled in the art will readily appreciate that the detailed description given herein with respect to these figures is for explanatory purposes only and should not be construed as limiting.

FIG. 1A illustrates a block diagram 100 of different components of an exemplary system configured to perform small data transmission (SDT). A wireless device 102 contains wireless circuitry that can receive cellular wireless transmissions from a cellular wireless network. A gNodeB 112 of the cellular wireless network can send reference signals, such as a synchronization signal block (SSB) 106, that the wireless device 102 can use to obtain timing and frequency synchronization for receiving communication from and for sending communication to the gNodeB 112 of the cellular wireless network. The gNodeB 112 can configure the wireless device to operate in a radio resource control (RRC) inactive state to conserve battery power and free RF resources for use by other wireless devices 102. Releases 15, 16, and 17 of 3GPP wireless communication standards introduced a small data transmission (SDT) feature to allow a wireless device 102 to transmit limited amounts of data while in the RRC inactive state without requiring the wireless device 102 to transition to a RRC connected state. Before sending an SDT 108, the wireless device 102 receives the SSB 106 to determine acquire DL timing synchronization, to allow the wireless device 102 to apply an uplink (UL) time advance (TA) adjustment relative to downlink (DL) frame boundaries to ensure proper reception of UL transmissions by the wireless device 102 to the gNodeB 112. The wireless device 102 validates a previously received and stored TA value before sending UL data to the gNodeB 112. Validation of the TA value includes measuring a current reference signal received power (RSRP) value using the SSB 106 and comparing the current RSRP value to a previously measured and stored RSRP value to determine whether the communication channel between the wireless device 102 and the gNodeB 112 has changed sufficiently to indicate that the previous TA value is stale. When the wireless device 102 has successfully acquiring timing synchronization and the TA value is validated, the wireless device 102 can send UL data to the gNodeB 112 during a configured grant SDT (CG-SDT) occasion. As discussed further herein, the wireless device 102 can update a stored RSRP value in response to one or more messages from the gNodeB 112 and/or based on a configuration of the wireless device 102. The wireless device 102 can use a beam sweeping mechanism to receive the SSB 106 via multiple antennas and combine RSRP sample values received by different receive beams to determine a current RSRP value.

FIG. 1B illustrates a state transition diagram 150 for a wireless device 102. The wireless device 102 can be in a RRC idle state 156 when associated with a cellular wireless network but without an active connection for data transmission and reception. The wireless device 102 can monitor paging channels, perform cell measurements, and receive system information from the cellular wireless network while in the RRC idle state 156. The wireless device 102 can send a RRC establish message 166 to the cellular wireless network to transition from the RRC idle state 156 to a RRC connected state 152, such as to initiate a mobile originated (MO) voice connection, to receive a mobile terminated (MT) voice connection, to receive DL data, or to send UI. data. After completion of communication with the wireless device 102 while in the RRC connected state 152, the cellular wireless network can send a RRC release message 162 to return the wireless device 102 to the RRC idle state 156. When the wireless device 102 has only small amounts of UI, data to transmit to the cellular wireless network, the signaling overhead to transition from the RRC idle state 156 to the RRC connected state 152 and to format and transmit the small amounts of UL data can be inefficient. Instead of sending the wireless device 102 from the RRC connected state 152 to the RRC idle state 156, the gNodeB 112 of a cellular wireless network can transition the wireless device 102 to a RRC inactive state 154 by sending a RRC release with suspend message 160. The RRC release with suspend message 160 can include a SDT configuration that indicates CG-SDT occasions on which the wireless device 102 can transmit limited amounts of UL data while remaining in the RRC inactive state 154 and not requiring the wireless device 102 to transition back to the RRC connected state 152 to transmit the limited amounts of UL data. The wireless device 102 can communicate UL data while in the RRC inactive state 154 using an SDT procedure on one or more CG-SDT occasions. Should the wireless device 102 require more radio resources than available via the SDT procedure, the wireless device 102 can return to the RRC connected state 152 via a RRC resume message 164. After completing UL data transmission via the SDT procedure, the wireless device 102 can remain in the RRC inactive state 154 after receiving an additional RRC release with suspend message 168 from the gNodeB 112 of the cellular wireless network. The additional RRC release with suspend message 168 can include an SDT configuration that indicates future CG-SDT occasions for the wireless device 102 to use for future small amounts of UL data. Alternatively, the wireless device 102 can transition to the RRC idle state 156 in response to a RRC release message 162 (without suspend or SDT configuration) from the gNodeB 112 of the cellular wireless network.

FIG. 1C illustrates a diagram 170 of a SDT signaling procedure including messaging between a wireless device 102 and a gNodeB 112 of a cellular wireless network. The wireless device 102 can receive, while in a RRC connected state 152, a RRC release with suspend message 160 from the gNodeB 112 including an SDT configuration. The wireless device 102. at 172, can suspend data radio bearers (DRBs) and transition to a RRC inactive state 154. The wireless device 102 can also suspend one or more signaling radio bearers (SRBs) while maintaining (or re-establishing) at least one SRB with the gNodeB 112 of the cellular wireless network. Within a time window of transitioning from the RRC connected state 152 to the RRC inactive state 154, the wireless device 102 can also measure and store a first reference signal received power (RSRP) value, referred to herein as RSRP1, to later use as part of a timing alignment (TA) validation procedure. At 174, the wireless device 102 determines pending UI. data is available for transmission to the gNodeB 112 of the cellular wireless network and also determines that one or more SDT criteria for using the SDT procedure while in the RRC inactive state 154 are satisfied. The wireless device 102 can resume a DRB to use for SDT transmissions At 176, the wireless device 102 sends an initial SDT transmission using a random-access channel (RACH) or via a configured grant (CG). At 178, the wireless device 102 sends additional SDT transmissions on one or more CG-SDT occasions. At the end of the SDT period 180, the gNodeB 112 sends a RRC release with suspend message 168 to the wireless device 102, which includes another SDT configuration indicating future CG-SDT occasions for the wireless device 102 to use for future SDT transmissions while remaining in the RRC inactive state 154. In some embodiments, within a time window of the RRC release with suspend message 168, the wireless device 102 can re-measure and store an updated RSRP1 value to later use as part of a timing alignment (TA) validation procedure.

FIG. 1D illustrates a diagram 190 of actions performed by a wireless device 102 for an SDT. The wireless device 102 can be in a RRC inactive state 154 having previously received a RRC release with suspend message 168 that includes a SDT configuration indicating CG-SDToccasions 192. The wireless device 102 measures a first RSRP value, referred to as RSRP1, by time T1′. The RSRP1 measurement can be triggered by a message received from the gNodeB 112 of the wireless device 102, such as after receipt of the RRC release with suspend message 168 or after receipt of a timing advance (TA) medium access control (MAC) control element (CE) that included a most recent TA value for the wireless device 102 to use for aligning UL transmissions sent to the gNodeB 112 relative to DL transmissions received from the gNodeB 112. The RSRP1 value can be stored for future use by the wireless device 102 during a timing advance (TA) validation procedure. Subsequently, the wireless device 102 determines UL data suitable for SDT transmission is available and that criteria for sending the UL data via SDT mechanisms are met. The wireless device 102 can transmit on a CG-SDT occasion 192 only after successfully acquiring timing synchronization with the gNodeB 112. The wireless device 102 can perform timing synchronization acquisition after completion of a TA validation procedure. The wireless device 102 measures a second RSRP value, referred to as an RSRP2 value, at time T2′ within an RSRP2 measurement window before performing the TA validation procedure at time T2. The wireless device 102 performs the TA validation procedure by comparing the RSRP2 value to the previously measured and stored RSRP1 value to determine whether the RSRP has changed (increased or decreased) by more than a CG-SDT RSRP change threshold configured by the gNodeB 112. For example, the wireless device 102 can calculate a magnitude of a difference between the RSRP1 and RSRP2 values and determine whether this magnitude exceeds the CG-SDT RSRP change threshold. The RSRP values provide an indication of signal strength for signals received from the gNodeB 112, and the difference between the recently measured RSRP value, RSRP2, and the previously measured RSRP1 value can indicate whether the signal strength has changed such that the most recent TA value received from the gNodeB 112 may no longer be valid. Changes in the received signal strength based on the RSRP values can indicate a change in path loss (for signal propagation between the gNodeB 112 and the wireless device 102), which can indicate a previously received, most recent TA value may be stale (no longer considered valid). After successfully validating the most recent TA value, the wireless device 102 can perform timing acquisition by receiving from the gNodeB 112 an SSB 106 (or a relevant portion thereof) during a timing synchronization occasion 194. Multiple timing synchronization occasions 194 can be available on which to acquire DL timing synchronization before a CG-SDT occasion 192. After successfully acquiring DL timing, the wireless device 102 can transmits the pending UL data on one or more CG-SDT occasions 192. Multiple CG-SDT occasions 192 can be available for the wireless device 102 to use.

The wireless device 102 can calculate and store a most recent RSRP1 value in response to receipt of different messages. In some embodiments, the cellular wireless network. e.g., via a message from the gNodeB 112, configures the wireless device 102 using a flag that indicates which messages should trigger an RSRP1 measurement. In some embodiments, the wireless device 102 is pre-configured to measure the RSRP1 value based on receipt of one or more configuration messages from the cellular wireless network. In some embodiments, the wireless device is configured for RSRP1 measurements based on a cellular wireless network setting provided to the wireless device in a carrier bundle that includes settings for one or more cellular wireless networks. In some embodiments, the wireless device is configured for RSRP1 measurements on a system information broadcast (SIB) message received from the cellular wireless network. In some embodiments, the RSRP1 value is calculated in response to receipt of an RRC release message 160 with an SDT configuration when transitioning the wireless device 102 from the RRC connected state 152 to the RRC inactive state 154. In some embodiments, the RSRP1 value is calculated in response to receipt of an RRC release message 160 with a SDT configuration while in the RRC inactive state 154, such as when initiating a new SDT session for the wireless device 102. In some embodiments, the RSRP1 value is calculated in response to receipt of a MAC CE TA command message or a random-access response (RAR) message that includes a new TA value. In some embodiments, the RSRP1 value is calculated in response to receipt of an RRC release message without a SDT configuration, such as when transitioning the wireless device 102 from the RRC connected state 152 or the RRC inactive state 154 to the RRC idle state 156. In some embodiments, the RSRP1 value is calculated in response to receipt of an RRC resume message 164 that transitions the wireless device 102 from the RRC inactive state 154 to the RRC connected state 152. To calculate the RSRP1 value (or the RSRP2 value), the wireless device 102 can use beam sweeping to receive and filter multiple RSRP sample values to generate the RSRP1 (or RSRP2) value.

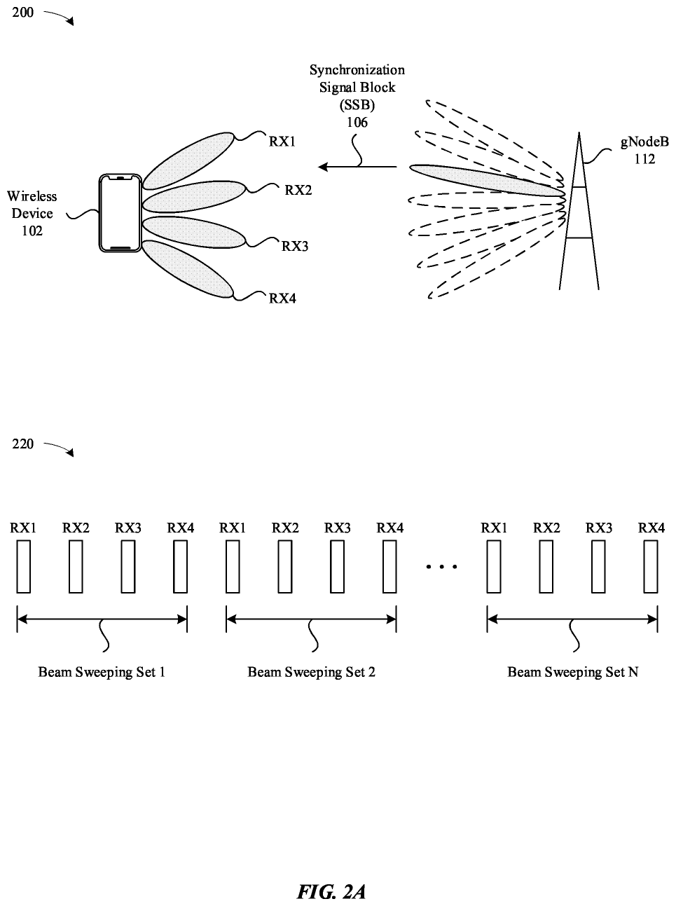

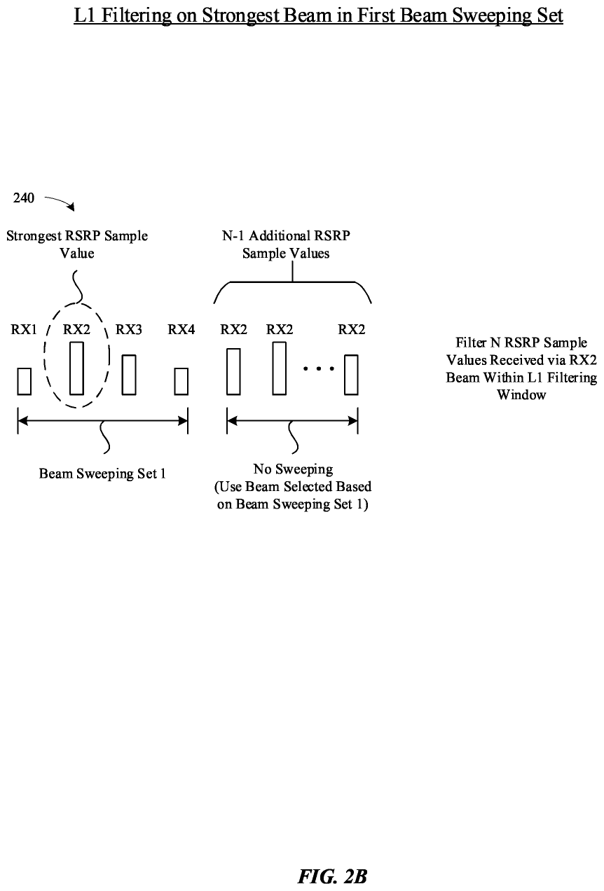

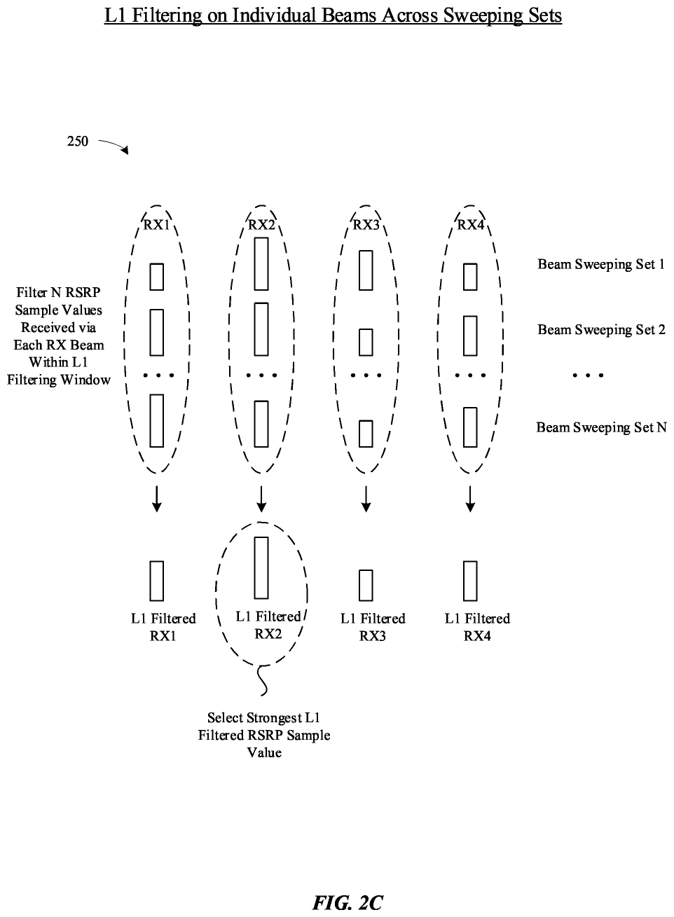

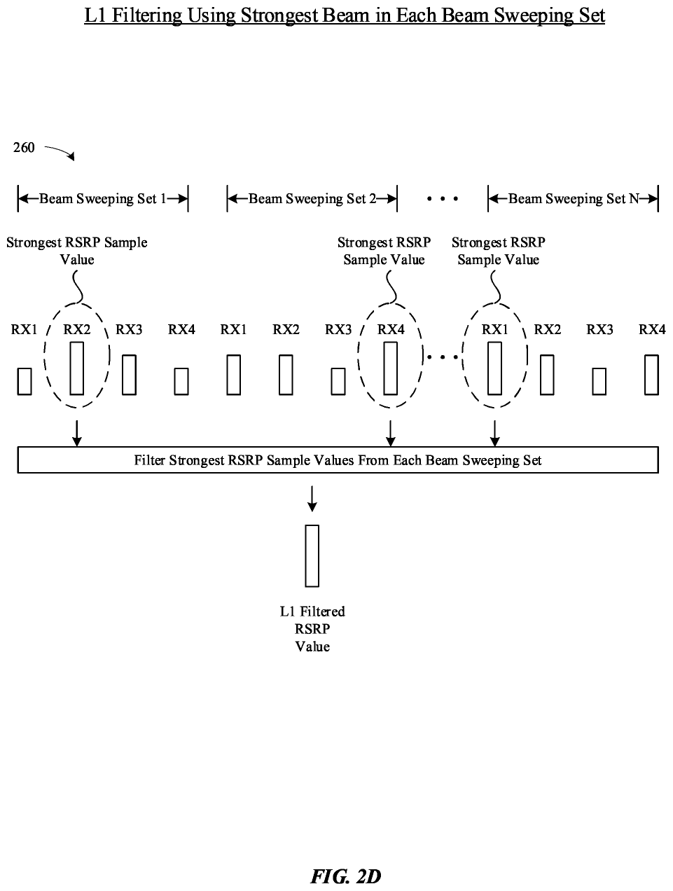

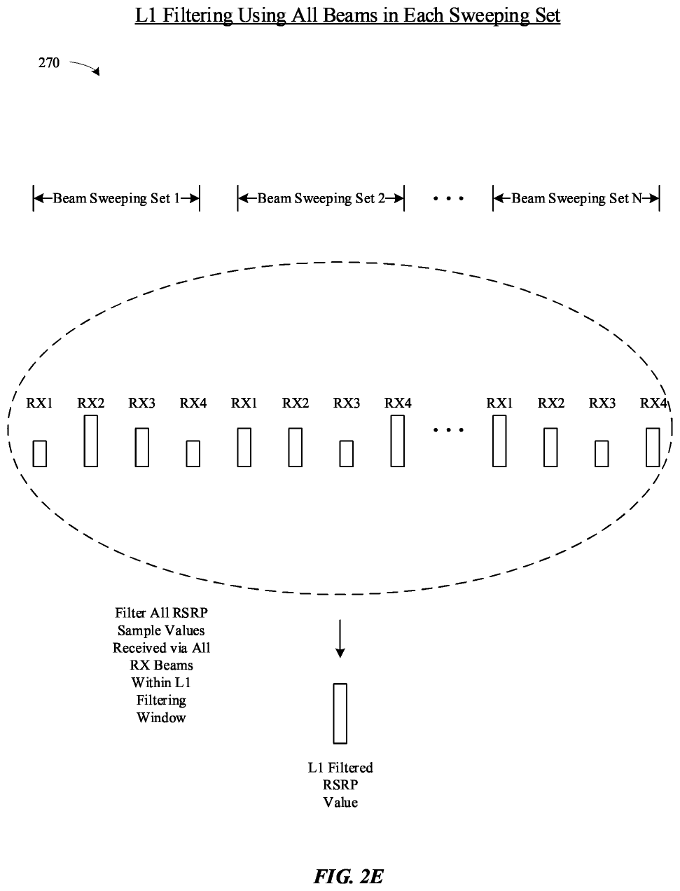

FIG. 2A illustrates diagrams 200, 220 of beam sweeping by a wireless device 102 to receive an SSB 106 from a gNodeB 112 of a cellular wireless network. The gNodeB 112 can send the SSB 106 at regular intervals, and the wireless device 102 can use the SSB 106 to acquiring timing and frequency synchronization information. The wireless device 102 can measure one or more reference signals included in the SSB 106 through multiple receive beams, e.g., via RX1, RX2, RX3, and RX4 generating one or more beam sweeping sets, each beam sweeping set including a reference signal received power (RSRP) sample value from each of the receive beams. The number of RSRP sample values to take can be pre-configured in the wireless device 102 or can be adaptively configured by the wireless device 102 based on channel conditions. The wireless device 102 can combine the RSRP sample values, e.g., using a physical layer one (L1) filtering mechanism, to generate an RSRP value. Additional filtering mechanisms are further illustrated in FIGS. 2B through 2E. The wireless device 102 can measure and store a first RSRP value associated with a TA value, e.g., an RSRP1 value as discussed hereinabove, and later, the wireless device 102 can measure a second RSRP value, e.g., a current RSRP value, to determine whether the TA value is valid to be used for UL timing alignment for sending SDT transmissions to the gNodeB 112.

FIG. 2B illustrates a diagram 240 of an L1 filtering mechanism for determining an RSRP value from measurements of an SSB 106 using beam sweeping by a wireless device 102. The wireless device 102 measures the SSB by sweeping through multiple receive beams to generate a first beam sweeping set of RSRP sample values, labeled RX1, RX2, RX3, and RX4. The wireless device 102 selects the receive beam having the strongest RSRP sample value in the first beam sweeping set, e.g., RX2, and subsequently measures the SSB via the RX2 receive beam one or more additional times (no additional beam sweeping) to collect N-1 additional RSRP sample values from the RX2 receive beam. The wireless device 102 then combines the N RSRP sample values received from the RX2 receive beam, e.g., using an averaging or weighted filter, to obtain an L1 filtered RSRP measurement value. The wireless device 102 can use this L1 filtered RSRP measurement value as part of a TA validation procedure, e g., storing the L1 filtered RSRP measurement value as an RSRP1 value associated with a TA value, using the L1 filtered RSRP measurement value as an RSRP2 value when validating the TA value, or updating a previously stored RSRP1 value.

FIG. 2C illustrates a diagram 250 of another L1 filtering mechanism for determining an RSRP value from measurements of an SSB 106 using beam sweeping by a wireless device 102. The wireless device 102 measures the SSB by sweeping through multiple receive beams to generate multiple beam sweeping sets of RSRP sample values, each beam sweeping set including an RSRP sample value from each of the receive beams. The wireless device 102 combines N different RSRP sample values for each receive beam, one RSRP sample value from each of the beam sweeping sets, e.g., using an L1 filtering mechanism, e.g., using an averaging or weighted filter, to produce a set of L1 filtered RSRP receive beam sample values, one for each receive beam. The wireless device 102 then selects the strongest L1 filtered RSRP sample value from the set of L1 filtered RSRP receive beam sample values as the L1 filtered RSRP measurement value, e.g., for RSRP1 or RSRP2.

FIG. 2D illustrates a diagram 260 of a further L1 filtering mechanism for determining an RSRP value from measurements of an SSB 106 using beam sweeping by a wireless device 102. The wireless device 102 measures the SSB by sweeping through multiple receive beams to generate multiple beam sweeping sets of RSRP sample values, each beam sweeping set including an RSRP sample value from each of the receive beams. The wireless device 102 selects a strongest RSRP sample value from each of the beam sweeping sets, where the strongest RSRP sample value can be from different receive beams, and then combines these N strongest RSRP sample values using an L1 filtering mechanism, e.g., an averaging or weighted filter, to generate an L1 filtered RSRP value to use, e.g., for RSRP1 or RSRP2.

FIG. 2E illustrates a diagram 270 of an additional L1 filtering mechanism for determining an RSRP value from measurements of an SSB 106 using beam sweeping by a wireless device 102. The wireless device 102 measures the SSB by sweeping through multiple receive beams to generate multiple beam sweeping sets of RSRP sample values, each beam sweeping set including an RSRP sample value from each of the receive beams. The wireless device 102 combines all RSRP sample values for all of the beam sweeping sets of RSRP sample values, e.g., using an L1 filtering mechanism, e.g., an averaging or weighted filter, to generate an L1 filtered RSRP value to use, e.g., for RSRP1 or RSRP2.

In the first L1 filtering mechanism of FIG. 2B, the wireless device 102 selects a receive beam based on a single beam sweeping set and then collects additional measurements for L1 filtering. In the second L1 filtering mechanism of FIG. 2C, the wireless device 102 generates an L1 filtered RSRP value for each beam from measurements using multiple beam sweeping sets and then selects the strongest L1 filtered beam sample value for the RSRP value In the third L1 filtering mechanism of FIG. 2D, the wireless device 102 generates an L1 filtered RSRP value using only the strongest RSRP sample value from each of the beam sweeping sets to use as the RSRP value. In the fourth L1 filtering mechanism of FIG. 2E, the wireless device 102 generates the RSRP value by L1 filtering all of the RSRP sample values in all of the beam sweeping sets.

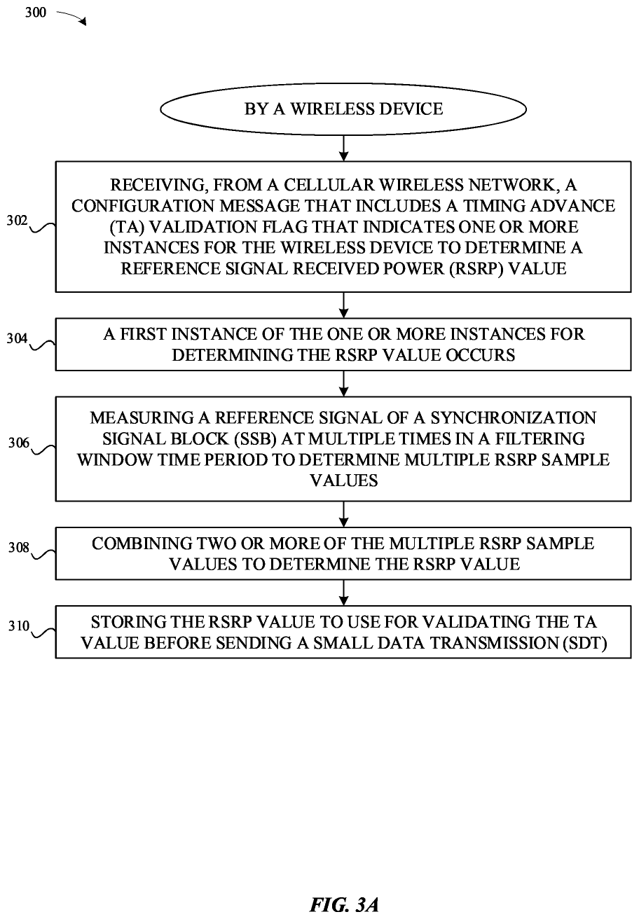

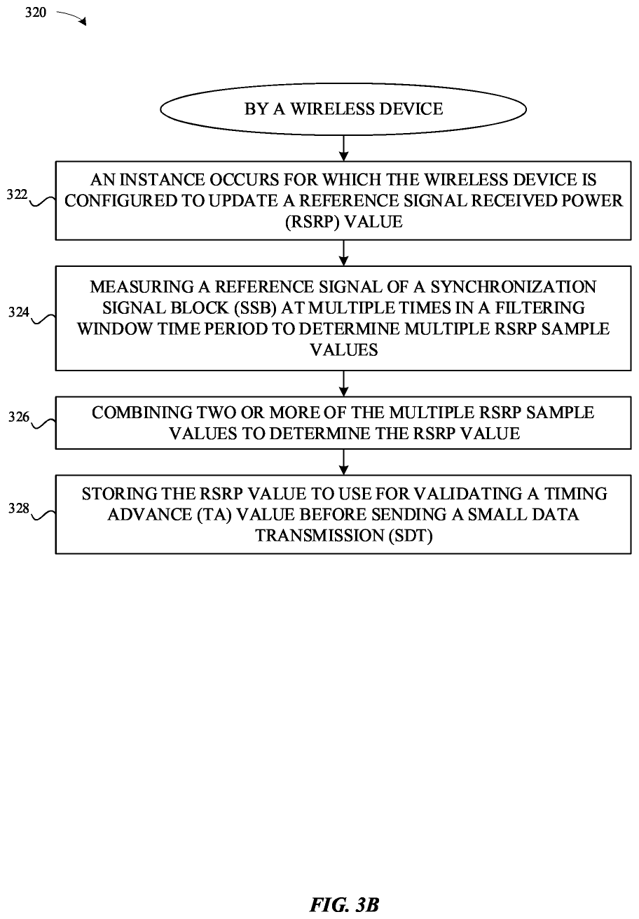

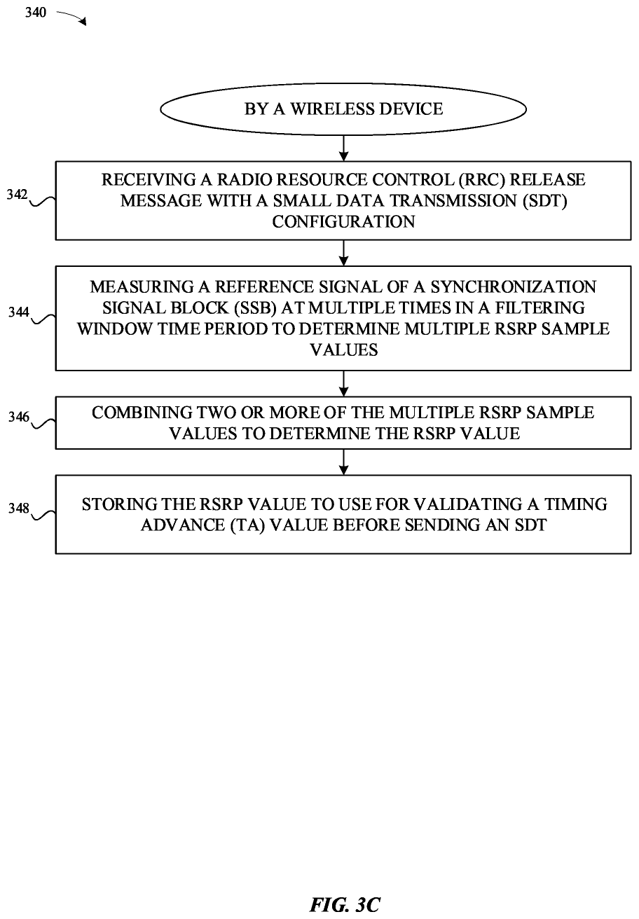

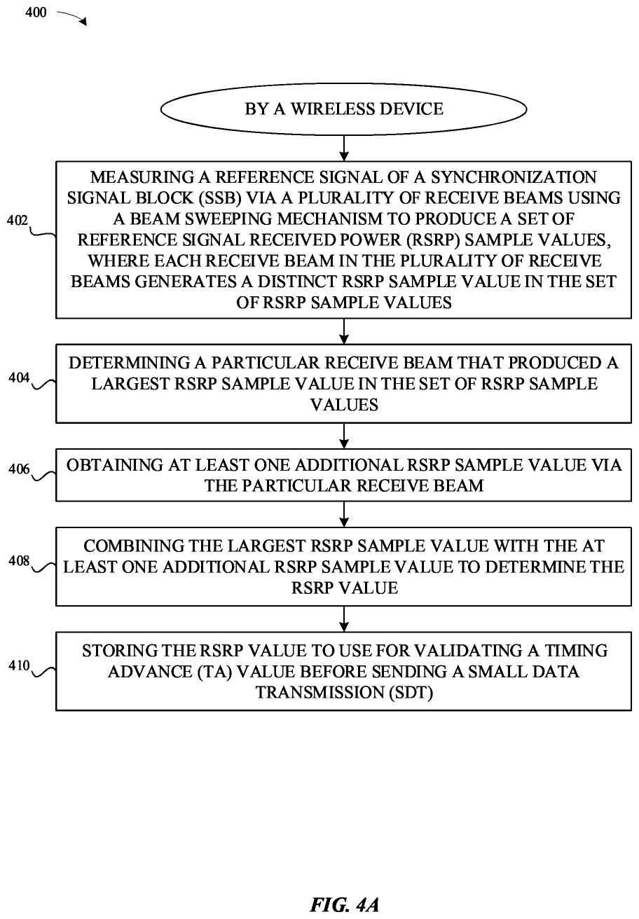

FIG. 3A illustrates a flowchart 300 of an exemplary method for a wireless device 102 to update an RSRP value, such as used for validating a TA value before sending a small data transmission (SDT) to a gNodeB 112 of a cellular wireless network. At 302, the wireless device 102 receives from the cellular wireless network a configuration message that includes a TA validation flag that indicates one or more instances for the wireless device 102 to determine an RSRP value. At 304, a first instance of the one or more instances for determining the RSRP value occurs. In response to the occurrence of the first instance, the wireless device 102, at 306, measures a reference signal of an SSB at multiple times in a filtering window time period to determine multiple RSRP sample values. At 308, the wireless device 102 combines two or more of the multiple RSRP sample values to determine the RSRP value. At 310, the wireless device 102 stores the RSRP value to use for validating the TA value before sending the SDT. The TA validation flag received in the configuration message from the cellular wireless network further indicates that the RSRP value is to be updated by the wireless device 102 in response to receipt of any one of: a radio resource control (RRC) release message, a TA command medium access control (MAC) control element (CE) message, or a random-access response (RAR) message.

In some embodiments, the TA validation flag further indicates that the RSRP value is only to be updated by the wireless device 102 based on receipt of RRC release messages with SDT configurations. In some embodiments. the TA validation flag prohibits the RSRP value from being updated by the wireless device 102 based on receipt of: i) RRC release messages without SDT configurations, ii) TA command MAC CE messages, and iii) RAR messages. In some embodiments, the TA validation flag further indicates that the RSRP value is only to be updated by the wireless device 102 based on receipt of TA MAC CE messages or RAR messages and excludes updating the RSRP value based on receipt of RRC release messages. In some embodiments, the wireless device 102, while in the RRC inactive state 154 after receipt of an RRC release message with SDT configuration, uses the RSRP value determined and stored in response to receipt of a most recently received TA MAC CE message or RAR message to validate the TA value before sending the SDT. In some embodiments, the most recently received TA MAC CE message or RAR message occurs before entering the RRC inactive state 154. In some embodiments, the most recently received TA MAC CE message or RAR message occurs while in the RRC inactive state 154. In some embodiments, the TA validation flag further indicates that the RSRP value is to be updated by the wireless device 102 based on receipt of: i) RRC release messages, with or without SDT configurations, ii) TA MAC CE messages, and iii) RAR messages.

In some embodiments, in response to occurrence of a second instance of the one or more instances, the wireless device 102: i) updates the RSRP value by re-measuring the reference signal of the SSB at multiple times in a second filtering window, ii) combines additional re-measured RSRP sample values to determine an updated RSRP value, and iii) stores the updated RSRP value in place of the RSRP value previously stored. In some embodiments, the first instance includes receipt of an RRC release message to transition the wireless device 102 from an RRC connected state 152 to an RRC inactive state 154 with an SDT configuration to use for a first SDT session by the wireless device 102 while in the RRC inactive state 154. In some embodiments, the second instance includes receipt of a second RRC release message to keep the wireless device 102 in the RRC inactive state 154 with a second SDT configuration to use for a second SDT session by the wireless device 102 while in the RRC inactive state 154.

FIG. 3B illustrates a flowchart 320 of another exemplary method for a wireless device 102 to update an RSRP value. At 322, an instance occurs for which the wireless device 102 is configured to update the RSRP value. At 324, the wireless device measures a reference signal of an SSB at multiple times in a filtering window time period to determine multiple RSRP sample values. At 326, the wireless device 102 combines two or more of the multiple RSRP sample values to determine the RSRP value. At 328, the wireless device 102 stores the RSRP value to use for validating a TA value before sending a SDT. Instances for which the wireless device 102 can be configured to update the RSRP value can include: i) receipt of a RRC release message 160 with an SDT configuration that causes the wireless device 102 to transition from a RRC connected state 152 to a RRC inactive state 154, ii) receipt of a TA MAC CE message while in the RRC inactive state 154, and iii) receipt of a RAR message while in the RRC inactive state 154. In some embodiments, the RRC release message with an SDT configuration includes the TA value. In some embodiments, the TA MAC CE message includes the TA value. In some embodiments, the RAR message includes the TA value.

FIG. 3C illustrates a flowchart 340 of another exemplary method for a wireless device 102 to update an RSRP value. At 342, the wireless device 102 receives a RRC release message 160, 168 with a SDT configuration. At 344, the wireless device 102 measures a reference signal of a SSB at multiple times in a filtering window time period to determine multiple RSRP sample values. At 346, the wireless device 102 combines two or more of the multiple RSRP sample values to determine the RSRP value. At 348, the wireless device 102 stores the RSRP value to use for validating a TA value before sending an SDT. In some embodiments, the wireless device 102 receives the RRC release message 160 with the SDT configuration while in an RRC connected state 152, and the wireless device 102 subsequently transitions from the RRC connected state 152 to an RRC inactive state 154 in response to receipt of the RRC release message 160 with the SDT configuration. In some embodiments, the wireless device 102 receives the RRC release message 168 with the SDT configuration while in an RRC inactive state 154, and the wireless device 102 subsequently remains in the RRC inactive state 154 in response to receipt of the RRC release message 168 with the SDT configuration.

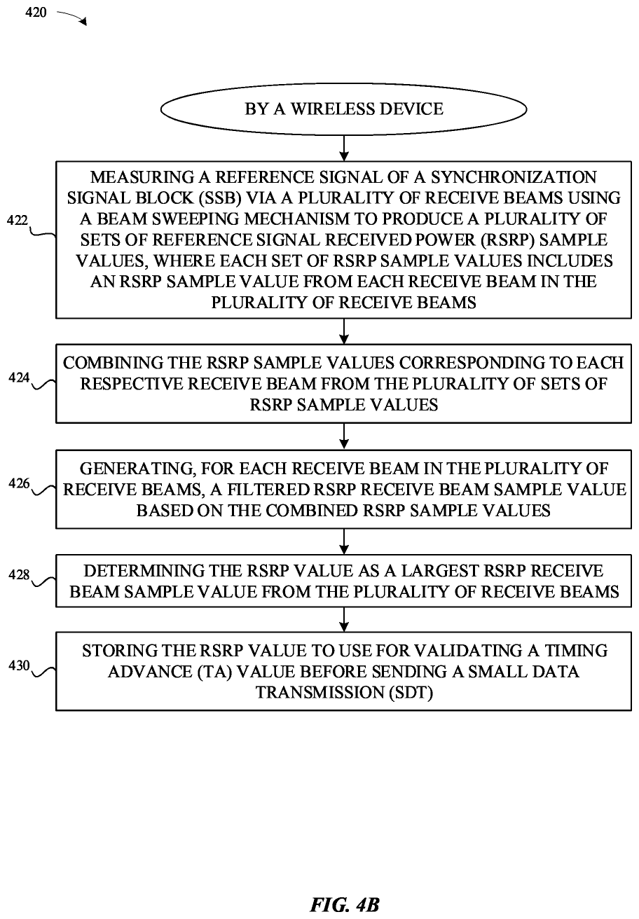

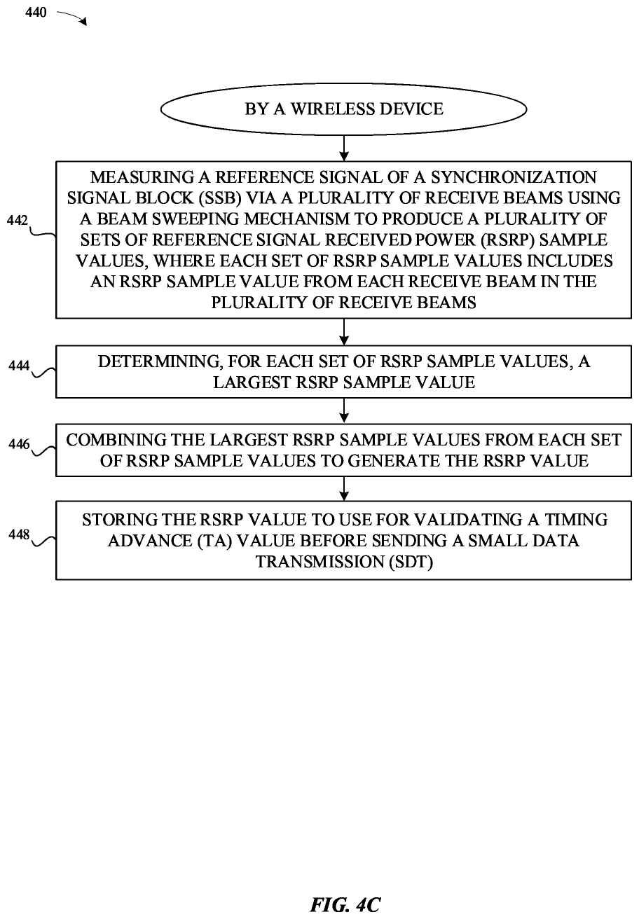

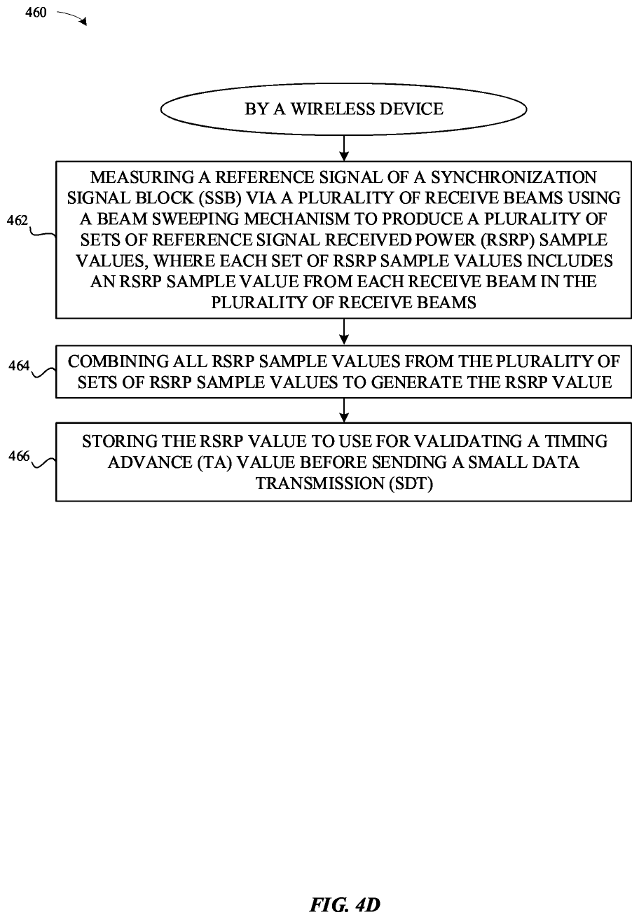

FIG. 4A illustrates a flowchart 400 of an exemplary method for determining a reference signal received power (RSRP) value for validating a timing advance (TA) value before a sending a small data transmission (SDT) by a wireless device 102. At 402, the wireless device 102 measures a reference signal of a synchronization signal block (SSB) via a plurality of receive beams using a beam sweeping mechanism to produce a set of RSRP sample values, where each receive beam in the plurality of receive beams generates a distinct RSRP sample value in the set of RSRP sample values. At 404, the wireless device 102 determines a particular receive beam that produced a largest RSRP sample value in the set of RSRP sample values. At 406, the wireless device 102 obtains at least one additional RSRP sample value via the particular receive beam. At 408, the wireless device 102 combines the largest RSRP sample value with the at least one additional RSRP sample value to determine the RSRP value. At 410, the wireless device 102 stores the RSRP value to use for validating the TA value before sending the SDT.

FIG. 4B illustrates a flowchart 420 of another exemplary method for determining a RSRP value for validating a TA value before sending an SDT by a wireless device 102. At 422, the wireless device 102 measures a reference signal of a SSB via a plurality of receive beams using a beam sweeping mechanism to produce a plurality of sets of RSRP sample values, where each set of RSRP sample values includes an RSRP sample value from each receive beam in the plurality of receive beams. At 424, the wireless device 102 combines the RSRP sample values corresponding to each respective receive beam from the plurality of sets of RSRP sample values. At 426, the wireless device 102 generates, for each receive beam in the plurality of receive beams, a filtered RSRP receive beam sample value based on the combined RSRP sample values corresponding to the receive beam. At 428, the wireless device 102 determines the RSRP value as a largest RSRP receive beam sample value from the plurality of receive beams. At 430, the wireless device 102 stores the RSRP value to use for validating the TA value before sending the SDT.

FIG. 4C illustrates a flowchart 440 of a further exemplary method for determining a RSRP value for validating a TA value before sending an SDT by a wireless device 102. At 442, the wireless device 102 measures a reference signal of an SSB via a plurality of receive beams using a beam sweep mechanism to produce a plurality of sets of RSRP sample values, where each set of RSRP sample values includes RSRP sample values from each receive beam in the plurality of receive beams. At 444, the wireless device 102 determines, for each set of RSRP sample values, a largest RSRP sample value. At 446, the wireless device 102 combines the largest RSRP sample values from each set of RSRP sample values to generate the RSRP value. At 448, the wireless device 102 stores the RSRP value to use for validating the TA value before sending the SDT.

FIG. 4D illustrates a flowchart 460 of an additional exemplary method for determining a RSRP value for validating a TA value before sending an SDT by a wireless device 102. At 462, the wireless device 102 measures a reference signal of an SSB via a plurality of receive beams using a beam sweep mechanism to produce a plurality of sets of RSRP sample values, where each set of RSRP sample values includes RSRP sample values from each receive beam in the plurality of receive beams. At 464, the wireless device 102 combines all RSRP sample values from the plurality of sets of RSRP sample values to generate the RSRP value. At 466, the wireless device 102 stores the RSRP value to use for validating the TA value before sending the SDT.

### Representative Exemplary Apparatus

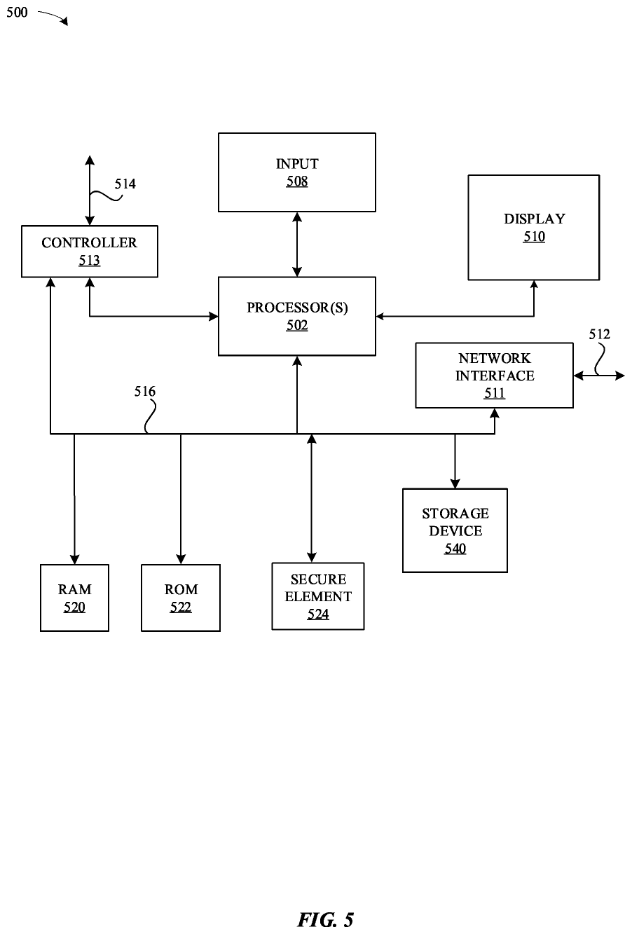

FIG. 5 illustrates in block diagram format an exemplary computing device 500 that can be used to implement the various components and techniques described herein, according to some embodiments. In particular, the detailed view of the exemplary computing device 500 illustrates various components that can be included in a wireless device 102. As shown in FIG. 5, the computing device 500 can include one or more processors 502 that represent microprocessors or controllers for controlling the overall operation of computing device 500. In some embodiments, the computing device 500 can also include a user input device 508 that allows a user of the computing device 500 to interact with the computing device 500. For example, in some embodiments, the user input device 508 can take a variety of forms, such as a button, keypad, dial, touch screen, audio input interface, visual/image capture input interface, input in the form of sensor data, etc. In some embodiments, the computing device 500 can include a display 510 (screen display) that can be controlled by the processor(s) 502 to display information to the user (for example, information relating to incoming, outgoing, or active communication sessions). A data bus 516 can facilitate data transfer between at least a storage device 540, the processor(s) 502, and a controller 513. The controller 513 can be used to interface with and control different equipment through an equipment control bus 514. The computing device 500 can also include a network/bus interface 511 that couples to a data link 512. In the case of a wireless connection, the network/bus interface 511 can include wireless circuitry, such as a wireless transceiver and/or baseband processor. The computing device 500 can also include a secure element 524. The secure element 524 can include an eUICC.

The computing device 500 also includes a storage device 540, which can include a single storage or a plurality of storages (e.g., hard drives), and includes a storage management module that manages one or more partitions within the storage device 540. In some embodiments, storage device 540 can include flash memory, semiconductor (solid state) memory or the like. The computing device 500 can also include a Random-Access Memory (RAM) 520 and a Read-Only Memory (ROM) 522. The ROM 522 can store programs, utilities or processes to be executed in a non-volatile manner. The RAM 520 can provide volatile data storage, and stores instructions related to the operation of the computing device 500.

### Wireless Terminology

In accordance with various embodiments described herein, the terms “wireless communication device,” “wireless device,” “mobile device,” “mobile station,” and “user equipment” (UE) may be used interchangeably herein to describe one or more common consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device. a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near field communication (NFC), a cellular wireless network, a fourth generation (4G) LTE, LTE Advanced (LTE-A), 5G, and/or 5G-Advanced or other present or future developed advanced cellular wireless networks.

The wireless communication device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments. the client device can be any wireless communication device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless communication devices that are also capable of communicating via different third generation (3G) and/or second generation (2G) RATs. In these scenarios, a multi-mode user equipment (UE) can be configured to prefer attachment to LTE networks offering faster data rate throughput, as compared to other 3G legacy networks offering lower data rate throughputs. For instance, in some implementations, a multi-mode UE may be configured to fall back to a 3G legacy network, e.g., an Evolved High Speed Packet Access (HSPA+) network or a Code Division Multiple Access (CDMA) 2000 Evolution-Data Only (EV-DO) network, when 5G, LTE and LTE-A networks are otherwise unavailable.

It is well understood that the use of personally identifiable information should follow privacy policies and practices that are generally recognized as meeting or exceeding industry or governmental requirements for maintaining the privacy of users. In particular. personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

1. A method for maintaining a reference signal received power (RSRP) value for validating a timing advance (TA) value before sending a small data transmission (SDT) by a wireless device, the method comprising:
by the wireless device:
receiving, from a cellular wireless network, a configuration message that includes a TA validation flag that indicates one or more instances for the wireless device to determine the RSRP value; and
in response to occurrence of a first instance of the one or more instances:
measuring a reference signal of a synchronization signal block (SSB) at multiple times in a filtering window time period to determine multiple RSRP sample values;
combining two or more of the multiple RSRP sample values to determine the RSRP value; and
storing the RSRP value to use for validating the TA value before sending the SDT,
wherein the TA validation flag further indicates that the RSRP value is to be updated based on receipt of any one of: a radio resource control (RRC) release message, a TA command medium access control (MAC) control element (CE) message, or a random-access response (RAR) message.

2. The method of claim 1, wherein the TA validation flag further indicates that the RSRP value is only to be updated based on receipt of RRC release messages with SDT configurations.

3. The method of claim 2, wherein the TA validation flag prohibits the RSRP value from being updated based on receipt of: i) RRC release messages without SDT configurations, ii) TA command MAC CE messages, and iii) RAR messages.

4. The method of claim 1, wherein the TA validation flag further indicates that the RSRP value is only to be updated based on receipt of TA MAC CE messages or RAR messages and excludes updating the RSRP value based on receipt of RRC release messages.

5. The method of claim 4, wherein the wireless device, while in an RRC inactive state after receipt of an RRC release message with SDT configuration, uses the RSRP value determined and stored in response to receipt of a most recently received TA MAC CE message or RAR message to validate the TA value before sending the SDT.

6. The method of claim 5, wherein the most recently received TA MAC CE message or RAR message occurs before entering the RRC inactive state.

7. The method of claim 5, wherein the most recently received TA MAC CE message or RAR message occurs while in the RRC inactive state.

8. The method of claim 1, wherein the TA validation flag further indicates that the RSRP value is to be updated based on receipt of: i) RRC release messages, with or without SDT configurations, ii) TA MAC CE messages, and iii) RAR messages.

9. The method of claim 1, further comprising:
by the wireless device:
in response to occurrence of a second instance of the one or more instances:
updating the RSRP value by re-measuring the reference signal of the SSB at multiple times in a second filtering window;
combining additional re-measured RSRP sample values to determine an updated RSRP value; and
storing the updated RSRP value in place of the RSRP value previously stored.

10. The method of claim 9, wherein:
the first instance comprises receipt of an RRC release message to transition the wireless device from an RRC connected state to an RRC inactive state with an SDT configuration to use for a first SDT session by the wireless device while in the RRC inactive state; and
the second instance comprises receipt of a second RRC release message to keep the wireless device in the RRC inactive state with a second SDT configuration to use for a second SDT session by the wireless device while in the RRC inactive state.

11. The method of claim 1, wherein the configuration message that includes the TA validation flag comprises a RRC release message with an SDT configuration.

12. A method for maintaining a reference signal received power (RSRP) value for validating a timing advance (TA) value before sending a small data transmission (SDT) by a wireless device, the method comprising:
by the wireless device:
receiving a radio resource control (RRC) release message with an SDT configuration;
measuring a reference signal of a synchronization signal block (SSB) at multiple times in a filtering window time period to determine multiple RSRP sample values;
combining two or more of the multiple RSRP sample values to determine the RSRP value; and
storing the RSRP value to use for validating the TA value before sending the SDT.

13. The method of claim 12, wherein:
the wireless device receives the RRC release message with the SDT configuration while in an RRC connected state, and
the method further comprises the wireless device subsequently transitioning from the RRC connected state to an RRC inactive state in response to receipt of the RRC release message with the SDT configuration.

14. The method of claim 12, wherein:
the wireless device receives the RRC release message with the SDT configuration while in an RRC inactive state, and
the method further comprises the wireless device subsequently remaining in the RRC inactive state in response to receipt of the RRC release message with the SDT configuration.

15. The method of claim 12, wherein the RRC release message with the SDT configuration includes a TA validation flag that indicates the RSRP value is to be updated based on receipt of a radio resource control (RRC) release message.

16. The method of claim 12, wherein the RRC release message with the SDT configuration includes a TA validation flag that indicates the RSRP value is to be updated based on receipt of a TA command medium access control (MAC) control element (CE) message.

17. The method of claim 12, wherein the RRC release message with the SDT configuration includes a TA validation flag that indicates the RSRP value is to be updated based on receipt of a random-access response (RAR) message.

18. An apparatus configurable for operation in a wireless device, the apparatus comprising one or more processors coupled to a memory storing instructions that, when executed by the one or more processors, configure the wireless device to maintain a reference signal received power (RSRP) value for validating a timing advance (TA) value before sending a small data transmission (SDT) by:
receiving, from a cellular wireless network, a configuration message that includes a TA validation flag that indicates one or more instances for the wireless device to determine the RSRP value; and
in response to occurrence of a first instance of the one or more instances:
measuring a reference signal of a synchronization signal block (SSB) at multiple times in a filtering window time period to determine multiple RSRP sample values;
combining two or more of the multiple RSRP sample values to determine the RSRP value; and
storing the RSRP value to use for validating the TA value before sending the SDT,
wherein the TA validation flag further indicates that the RSRP value is to be updated based on receipt of any one of: a radio resource control (RRC) release message, a TA command medium access control (MAC) control element (CE) message, or a random-access response (RAR) message.

19. The apparatus of claim 18, wherein the TA validation flag further indicates that the RSRP value is only to be updated based on receipt of RRC release messages with SDT configurations.

20. The apparatus of claim 19, wherein the TA validation flag prohibits the RSRP value from being updated based on receipt of: i) RRC release messages without SDT configurations, ii) TA command MAC CE messages, and iii) RAR messages.
